(19) United States
(12) Patent Application Publication
(10) Pub. No.: US 2002/0045081 A1
(43) Pub. Date: Apr. 18, 2002

(54) Electrolyte membrane/electrode assembly of solid polymer electrolyte fuel cell

(76) Inventors: Masaaki Nanaumi, Wako-shi (JP); Yoichi Asano, Wako-shi (JP); Nobuhiro Saito, Wako-shi (JP); Nagayuki Kanaoka, Wako-shi (JP); Kaoru Fukuda, Wako-shi (JP)

Correspondence Address: ARENT FOX KINTNER, PLOTKIN & KAHN, PLLC, Suite 400, 1050 Connecticut Avenue, N.W., Washington, DC, 20036-5339, US

(21) Appl. No.: 09/897,426

(22) Filed: Jul. 3, 2001

(30) Foreign Application Priority Data
Jul. 5, 2000 (JP) 2000-204131
Aug. 25, 2000 (JP) 2000-256157

(51) Int. Cl. H01M 8/10; H01M 4/86

(52) U.S. Cl. 429/30; 429/33; 429/29; 429/41

(57) ABSTRACT

An electrolyte membrane/electrode assembly 9 of a solid polymer electrolyte fuel cell includes an electrolyte membrane 2, and an air pole 3 and a fuel pole 4 provided to sandwich the electrolyte membrane 2 therebetween. Each of the electrolyte membrane, the air pole and the fuel pole includes a polymer ion-exchange component. The electrolyte membrane/electrode assembly has an ion-exchange capacity Ic in a range of 0.9 meq/g≦Ic≦5 meq/g, and a dynamic viscoelastic modulus at 85° C. in a range of 5×10⁸ Pa≦Dv≦1×10¹⁰ Pa. In the electrolyte membrane/electrode assembly 9, a high power-generating performance can be maintained at an operating temperature not lower than 85° C.

### BACKGROUND OF THE INVENTION

1. Field of the Invention

The present invention relates to an electrolyte membrane/electrode assembly of a solid polymer electrolyte fuel cell and particularly, to an electrolyte membrane/electrode assembly comprising an electrolyte membrane, and an air pole and a fuel pole provided to sandwich the electrolyte membrane therebetween, each of the electrolyte membrane, the air pole and the fuel pole including a polymer ion-exchange component.

2. Description of the Related Art

If water produced during generation of power resides in the assembly of the solid polymer electrolyte fuel cell, the power-generating performance is reduced. Therefore, it is a conventional attempt to set the operating temperature at 85° C. or higher to increase the vapor pressure of the produced water, thereby discharging the produced water out of the assembly.

However, the water in the assembly tends to be excessively discharged. In addition, the conventional assembly has a problem that the power-generating performance is lowered, because the assembly does not have an electric resistance small enough to be able to deal with the excessive discharge of the water.

In a cell stack, a plurality of cells are clamped in order to reduce the contact resistance due to the lamination of the cells. The conventional assembly, however, has the following problem: At an operating temperature of 85° C., the thinning of the cell is caused by a creep due to the clamping, and as a result, the leakage of a gas occurs to cause a decrease in power-generating performance.

On the other hand, a fluorine resin-based ion exchanger is used as a polymer ion-exchange component in this type of assembly. However, the fluorine resin-based ion exchanger is generally insoluble in a solvent and for this reason, it is actually impossible to recover and reuse the fluorine resin-based ion exchanger, which is uneconomical.

Another problem is as follows: To recover catalyst particles included in each of an air pole and a fuel pole, e.g., catalyst particles comprising a plurality of platinum (Pt) particles carried on carbon black particles, the assembly is burned, because the air pole, the fuel pole and the electrolyte membrane are generally formed integrally by hot-pressing. However, the workability of the recovery by the burning is poor.

### SUMMARY OF THE INVENTION

Accordingly, it is an object of the present invention to provide an assembly of the above-described type, wherein a high power-generating performance can be maintained at an operating temperature of 85° C. or higher.

To achieve the above object, according to a first feature of the present invention, there is provided an electrolyte membrane/electrode assembly of a solid polymer electrolyte fuel cell, comprising an electrolyte membrane, and an air pole and a fuel pole provided to sandwich the electrolyte membrane therebetween, each of the electrolyte membrane, the air pole and the fuel pole including a polymer ion-exchange component, wherein the electrolyte membrane/electrode assembly has an ion-exchange capacity Ic in a range of 0.9 meq/g≦Ic≦5 meq/g, and a dynamic viscoelastic modulus at 85° C. in a range of 5×10⁸ Pa≦Dv≦1×10¹⁰ Pa.

If the ion-exchange capacity Ic of the assembly is set in the above-described range, even when water in the assembly has been excessively discharged at an operating temperature of 85° C. or higher, the power-generating performance can be maintained at a high level, because the assembly has a low electric resistance. However, if the ion-exchange capacity Ic is lower than 0.9 meq/g, the electric resistance of the assembly cannot be maintained at a low level. On the other hand, if Ic>5 meq/g, the power-generating performance at a high current density is lowered. This is considered to be because if Ic>5 meq/g, water is liable to reside in the air pole and the fuel pole.

In addition, if the dynamic viscoelastic modulus Dv of the assembly at 85° C. is set in the above-described range, the assembly exhibits an excellent creep resistance against the clamp pressure on the construction of the stack at an operating temperature higher than 85° C., whereby the thinning of the stack is avoided and thus, the power-generating performance can be maintained at a high level. However, if the dynamic viscoelastic modulus Dv is lower than 5×10⁸ Pa, the creep resistance of the assembly at the above-described operating temperature is low. On the other hand, if Dv>1×10¹⁰ Pa, the hardness of the electrolyte membrane, the air pole and the fuel pole is increased, and hence, when the electrolyte membrane, the air pole and the fuel pole are bonded together to constitute the assembly, the boning property is degraded.

According to a second feature of the present invention, there is provided an electrolyte membrane/electrode assembly of a solid polymer electrolyte fuel cell, wherein if the weight of the catalyst particles included in each of the air pole and the fuel pole is represented by W, and the weight of polymer ion-exchange component included in each of the air pole and the fuel pole is represented by X, the ratio X/W of the weights W and X is in a range of 0.05≦X/W≦0.80.

If the ratio X/W of the weights of the catalyst particles and the polymer ion-exchange component in each of the air pole and the fuel pole is set in the above-described range in addition to the ion-exchange capacity Ic and the dynamic viscoelastic modulus Dv, the power-generating performance at the above-described temperature can be maintained at a higher level.

It is another object of the present invention to provide an assembly of the above-described type, wherein the use of a particular substance as the polymer ion-exchange component ensure that the electrolyte membrane can be recovered and reused, and the catalyst particles included in the air pole and the fuel pole can be easily recovered.

To achieve the above object, according to a third feature of the present invention, there is provided an electrolyte membrane/electrode assembly of a solid polymer electrolyte fuel cell, comprising an electrolyte membrane, and an air pole and a fuel pole provided to sandwich the electrolyte membrane therebetween, each of the electrolyte membrane, the air pole and the fuel pole including a polymer ion-exchange component, wherein the polymer ion-exchange component is an aromatic hydrocarbon polymer ion-exchange component free of fluorine and soluble in a solvent.

When the assembly is immersed into a solvent, the aromatic hydrocarbon polymer ion-exchange components in the air pole and the fuel pole located at outer sides are dissolved, whereby the recovery of the catalyst particles is achieved. Thereafter, undissolved material is removed from the solvent, that is, the electrolyte membrane which is the undissolved material, is recovered. This recovered material can be used as a membrane-forming material to produce a new electrolyte membrane.

According to a fourth feature of the present invention, there is provided an electrolyte membrane/electrode assembly of a solid polymer electrolyte fuel cell, wherein the electrolyte membrane includes a first aromatic hydrocarbon ion-exchange component, and each of the air pole and the fuel pole includes a second aromatic hydrocarbon ion-exchange component, the solubilities of the first and second aromatic hydrocarbon ion-exchange components in a solvent being such that the solubility of the second aromatic hydrocarbon ion-exchange component is larger than that of the first aromatic hydrocarbon ion-exchange component.

With such configuration, the second aromatic hydrocarbon ion-exchange component tends to be thermally deteriorated greatly because each of the air pole and the fuel pole is extremely close to a site where a catalytic reaction occurs. Therefore, the second aromatic hydrocarbon ion-exchange component can be recovered and discarded earlier than the electrolyte membrane, so that the purity of the first polymer ion-exchange component in the electrolyte membrane can be enhanced, and the recovery rate of the catalyst particles and the electrolyte membrane can be further increased.

The above and other objects, features and advantages of the invention will become apparent from the following description of the preferred embodiment taken in conjunction with the accompanying drawings.

### BRIEF DESCRIPTION OF THE DRAWINGS

FIG. 1 is a schematic side view of a solid polymer electrolyte fuel cell;

FIG. 2 is a graph showing a relationship between ion-exchange capacity Ic and cell potential at a current density of 1 A/cm²;

FIG. 3 is a graph showing a relationship between dynamic viscoelastic modulus Dv and decrement in thickness as well as the cell potential at the current density of 1 A/cm²;

FIG. 4 is a graph showing a relationship between ratio X/W of weight V of a polymer ion-exchange component to weight W of catalyst particles and the cell potential at the current density of 1 A/cm²;

FIG. 5 is a graph showing a relationship between ratio B/A of average molecular weights and recovery rate F of a first polymer ion-exchange component as well as ratio percent K of the thickness-retaining rates; and

FIG. 6 is a graph showing a relationship between the current density and the terminal potential in solid polymer electrolyte fuel cells made using example (17) and comparative example (7).

### DESCRIPTION OF THE PREFERRED EMBODIMENT

(First Embodiment)

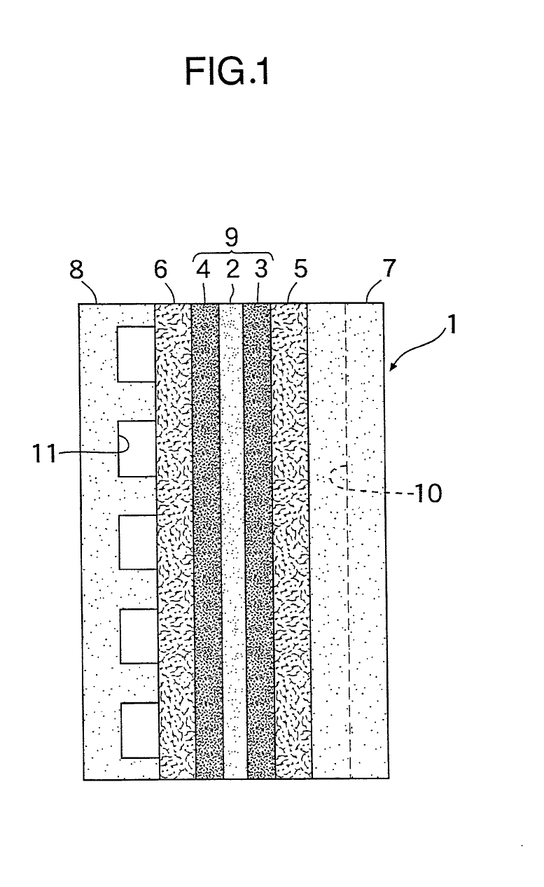

Referring to FIG. 1, a solid polymer electrolyte fuel cell 1 comprises an electrolyte membrane 2; an air pole 3 and a fuel pole 4 which are closely adhered to opposite sides of the electrolyte membrane 2, respectively; two diffusion layers 5 and 6 closely adhered to the poles 3 and 4, respectively; and a pair of separators 7 and 8 closely adhered to the diffusion layers 5 and 6, respectively. The electrolyte membrane 2, the air pole 3 and the fuel pole 4 constitute an electrolyte membrane/electrode assembly 9.

The electrolyte membrane 2 is formed of a polymer ion-exchange component. Each of the air pole 3 and the fuel pole 4 includes a plurality of catalyst particles having a plurality of Pt particles carried on surfaces of carbon black particles and a polymer ion-exchange component same as or different from the above-mentioned polymer ion-exchange component.

Each of the diffusion layers 5 and 6 is formed of a porous carbon paper, a carbon plate or the like, and each of the separators 7 and 8 is formed of graphitized carbon so as to have the same-form. Air is supplied to a plurality of grooves 10 provided in the separator 7 on the side of the air pole 3, and hydrogen is supplied to a plurality of grooves 11 provided in the separator 8 on the side of the fuel pole 4 so as to intersect the grooves 10.

The solid polymer electrolyte fuel cell is operated at a high temperature equal to or higher than 85° C. From the viewpoint to maintain the power generating performance at a high level during operation of the fuel cell at the high temperature, the ion-exchange capacity Ic of the electrolyte membrane/electrode assembly 9 is set in a range of 0.9 meq/g≦Ic≦5 meq/g, and the dynamic viscoelastic modulus Dv at 85° C. is set in a range of 5×10⁸ Pa≦Dv≦1×10¹⁰ Pa.

Examples of the polymer ion-exchange component are sulfonated substances of aromatic hydrocarbon polymers such as polyether-ether ketone (PEEK), polyether sulfone (PES), polysulfone (PSF), polyetherimide (PEI), polyphenylene sulfide (PPS), polyphenylene oxide (PPO); sulfonated substances of fluorine resins such as polytetrafluoroethylene (PTFE).

If the weight of the catalyst particles included in each of the air pole 3 and the fuel pole 4 is represented by W, and the weight of the polymer iron-exchange component included in each of the air pole 3 and the fuel pole 4 is represented by X, then the ratio X/W of the weights X and W included in one of the electrodes is set in a range of 0.02≦X/W≦1.0, preferably, in a range of 0.05≦X/W≦0.8.

If the ratio X/W of the weights of the catalyst particles and the polymer ion-exchange component in each of the air pole 3 and the fuel pole 4 is set in the above-described range in addition to the ion-exchange capacity Ic and the dynamic viscoelastic modulus Dv, the power-generating performance can be maintained at a higher level.

Particular Examples will be described below.

I. Production of Electrolyte Membrane/Electrode Assembly

Platinum (Pt) particles having an average particle size of 3 nm were carried on carbon black particles (furnace black) to prepare catalyst particles including the Pt particles in a content of 50% by weight. The average particle size of the Pt particles was measured by an X-ray diffractometry in all the following examples.

### EXAMPLE I

To produce a sulfonated substance of PEEK as described above, which is a polymer ion-exchange component, PEEK (made under a trade name of ALDRICH) was placed into fuming sulfuric acid and subjected to a sulfonating treatment, until the ion-exchange capacity Ic reached 2.4 meq/g.

An electrolyte membrane 2 having a thickness of 50 μm was formed using the sulfonated PEEK. In addition, the sulfonated PEEK was dissolved into NMP (N-methylpyrrolidone made under a trade name of ALDRICH) under ref lux to prepare a 12% by weight solution of the sulfonated PEEK in the NMP.

Catalyst particles were mixed into the solution including the sulfonated PEEK, so that the ratio of the weight X of the sulfonated PEEK to the weight W of the catalyst particles equals 1.25:2 (X/W≈0.63). Then, the catalyst particles were dispersed using a ball mill, thereby preparing a slurry for each of an air pole 3 and a fuel pole 4.

Carbon black particles and PTFE particles were mixed into and dispersed in ethylene glycol to provide a slurry. This slurry was applied onto one side of carbon paper and dried to form a primary coat, and then, diffusion layers 5 and 6 each comprising the carbon paper and the primary coat were produced.

The slurry for each of an air pole 3 and a fuel pole 4 was applied onto the primary coat of each of the diffusion layers 5 and 6 so that a Pt content of 0.5 mg/Cm² was obtained; and subjected to drying for 10 minutes at 60° C. and then to vacuum drying at 120° C. to form an air pole 3 and a fuel pole 4.

The air pole 3 and the fuel pole 4 integral with the diffusion layers 5 and 6 were put on opposite sides of the electrolyte membrane 2, respectively and subjected to a primary hot-pressing under conditions of 80° C., 5 MPa and 2 minutes, and then to a secondary hot-pressing under conditions of 160° C., 4 MPa and 1 minute to provide an electrolyte membrane/electrode assembly 9 having a pair of the diffusion layers 5 and 6. This electrolyte membrane/electrode assembly 9 is hereinafter referred to as example (1).

### EXAMPLE II

A sulfonated PEEK having an ion-exchange capacity Ic equal to 2.4 meq/g as in EXAMPLE I was prepared as a polymer ion-exchange component, and Nafion 112 (which is an ion-exchange membrane of a fluorine resin made by Du Pont) was prepared as an electrolyte membrane 2.

Thereafter, a procedure similar to that in EXAMPLE I, except that the temperature in the secondary hot-pressing was set at 120° C., was carried out to provide an electrolyte membrane/electrode assembly 9 similar to that described above. This electrolyte membrane/electrode assembly 9 is hereinafter referred to as example (2).

### EXAMPLE III

A sulfonated PEEK having an ion-exchange capacity Ic equal to 0.9 meq/g was prepared as a polymer ion-exchange component, and a membrane having a thickness of 50 μm and formed using sulfonated PEEK having an ion-exchange capacity Ic equal to 2.4 meq/g as in EXAMPLE I was prepared as an electrolyte membrane 2.

Thereafter, a procedure similar to that in EXAMPLE I was carried out to provide an electrolyte membrane/electrode assembly 9 similar to that described above. This electrolyte membrane/electrode assembly 9 is hereinafter referred to as example (3).

### EXAMPLE IV

A sulfonated PEEK having an ion-exchange capacity Ic equal to 2.4 meq/g as in EXAMPLE I was prepared as a polymer ion-exchange component, and a membrane having a thickness of 50 μm and formed using the sulfonated PEEK, i.e., a membrane similar to that in EXAMPLE I, was prepared as an electrolyte membrane 2.

Thereafter, an electrolyte membrane/electrode assembly 9 similar to that described above was produced by carrying out the process similar to that in EXAMPLE I, except that in a state in which NMP remained after drying for 10 minutes at 60° C. in the process of formation of an air pole 3 and a fuel pole 4, the air pole 3 and the fuel pole 4 were put on opposite sides of the electrolyte membrane 2, respectively and subjected to hot-pressing under conditions of 160° C., 4 MPa and 1 minute. This electrolyte membrane/electrode assembly 9 is hereinafter referred to as example (4).

### EXAMPLE V

A sulfonated PEEK having an ion-exchange capacity Ic equal to 2.4 meq/g as in EXAMPLE I was prepared as a polymer ion-exchange component, and a membrane having a thickness of 50 μm and formed using the sulfonated PEEK, i.e., a membrane similar to that in EXAMPLE I, was prepared as an electrolyte membrane 2.

Thereafter, an electrolyte membrane/electrode assembly 9 similar to that described above was produced by carrying out a procedure similar to that in EXAMPLE I, except that the ratio of the weight X of the sulfonated PEEK to the weight W of catalyst particles was set at 0.1:2 (X/W=0.05) in the preparation of an air pole 3 and a fuel pole 4, and in a state in which NMP remained after drying for 10 minutes at 60° C. in the process of formation of the air pole 3 and the fuel pole 4, the air pole 3 and the fuel pole 4 were put on opposite sides of the electrolyte membrane 2, respectively and subjected to hot-pressing under conditions of 160° C., 4 MPa and 1 minute. This electrolyte membrane/electrode assembly 9 is hereinafter referred to as example (5).

### EXAMPLE VI

A sulfonated PEEK having an ion-exchange capacity Ic equal to 2.4 meq/g as in EXAMPLE I was prepared as a polymer ion-exchange component, and a membrane having a thickness of 50 μm and formed using such sulfonated PEEK, i.e., a sulfonated PEEK similar to that in EXAMPLE I, was prepared as an electrolyte membrane 2.

Thereafter, an electrolyte membrane/electrode assembly 9 similar to that described above was produced by carrying out a procedure similar to that in EXAMPLE I, except that the ratio of the weight X of the sulfonated PEEK to the weight W of catalyst particles was set at 1.6:2 (X/W=0.80) in the preparation of an air pole 3 and a fuel pole 4, and in a state in which NMP remained after drying for 10 minutes at 60° C. in the process of formation of the air pole 3 and the fuel pole 4, the air pole 3 and the fuel pole 4 were put on opposite sides of the electrolyte membrane 2, respectively and subjected to hot-pressing under conditions of 160° C., 4 MPa and 1 minute. This electrolyte membrane/electrode assembly 9 is hereinafter referred to as example (6).

### EXAMPLE VII

A sulfonated PEEK having an ion-exchange capacity Ic equal to 2.4 meq/g as in EXAMPLE I was prepared as a polymer ion-exchange component. A membrane having a thickness of about 80 μm (formed using a sulfonated PEEK-PEI produced by placing a mixture of PEEK (made under a trade name of ALDRICH) and PEI (made under a trade name of ALDRICH) into fuming sulfuric acid and subjecting it to a sulfonating treatment, until an ion-exchange capacity Ic nearly equal to 0.95 meq/g was obtained) was prepared as an electrolyte membrane 2.

Thereafter, a procedure similar to that in EXAMPLE I was carried out to produce an electrolyte membrane/electrode assembly 9 similar to that described above. This electrolyte membrane/electrode assembly 9 is hereinafter referred to as example (7).

### EXAMPLE VIII

A sulfonated PEEK having an ion-exchange capacity Ic equal to 2.4 meq/g as in EXAMPLE I was prepared as a polymer ion-exchange component. A membrane having a thickness of about 80 μm (formed using a sulfonated PEEK-PEI produced by placing a mixture of PEEK (made under a trade name of ALDRICH) and PEI (made under a trade name of ALDRICH) into fuming sulfuric acid and subjecting it to a sulfonating treatment, until an ion-exchange capacity Ic nearly equal to 5.1 meq/g was obtained) was prepared as an electrolyte membrane 2.

Thereafter, a procedure similar to that in EXAMPLE I was carried out to produce an electrolyte membrane/electrode assembly 9 similar to that described above. This electrolyte membrane/electrode assembly 9 is hereinafter referred to as example (8).

### EXAMPLE IX

A sulfonated PEEK having an ion-exchange capacity Ic equal to 2.4 meq/g as in EXAMPLE I was prepared as a polymer ion-exchange component, and Nafion 112 (which is an ion-exchange membrane of a fluorine resin made by Du Pont) was prepared as an electrolyte membrane 2.

Thereafter, a procedure similar to that in EXAMPLE I, except that the ratio of the weight X of the sulfonated PEEK to the weight W of catalyst particles was set at 0.03:2 (X/W≈0.02) in the preparation of a slurry for each of an air pole 3 and a fuel pole 4, was carried out to provide an electrolyte membrane/electrode assembly 9 similar to that described above. This electrolyte membrane/electrode assembly 9 is hereinafter referred to as example (9).

### EXAMPLE X

A sulfonated PEEK having an ion-exchange capacity Ic equal to 2.4 meq/g as in EXAMPLE I was prepared as a polymer ion-exchange component, and Nafion 112 (which is an ion-exchange membrane of a fluorine resin made by Du Pont) was prepared as an electrolyte membrane 2.

Thereafter, a procedure similar to that in EXAMPLE I, except that the ratio of the weight X of the sulfonated PEEK to the weight W of catalyst particles was set at 1:1 (X/W≈1.0) in the preparation of a slurry for each of an air pole 3 and a fuel pole 4, was carried out to provide an electrolyte membrane/electrode assembly 9 similar to that described above. This electrolyte membrane/electrode assembly 9 is hereinafter referred to as example (10).

### EXAMPLE XI

A sulfonated PEEK having an ion-exchange capacity Ic equal to 1.1 meq/g as in EXAMPLE I was prepared as a polymer ion-exchange component, and a membrane having a thickness of 50 μm and formed using a sulfonated PETFE similar to that described above and having 1.1 meq/g was prepared as an electrolyte membrane 2.

Thereafter, a procedure similar to that in EXAMPLE I, except that the hot-pressing was carried out under conditions of 160° C., 4 MPa and 1 minute, was carried out to provide an electrolyte membrane/electrode assembly 9 similar to that described above. This electrolyte membrane/electrode assembly 9 is hereinafter referred to as comparative example (1).

### EXAMPLE XII

A sulfonated PEEK having an ion-exchange capacity Ic equal to 2.4 meq/g as in EXAMPLE I was prepared as a polymer ion-exchange component, and Nafion 112 (which is an ion-exchange membrane of a fluorine resin made by Du Pont) was prepared as an electrolyte membrane 2.

Thereafter, a procedure similar to that in EXAMPLE I, except that the ratio of the weight X of the sulfonated PEEK to the weight W of catalyst particles was set at 0.8:2 (X/W=0.4) in the preparation of a slurry for each of an air pole 3 and a fuel pole 4, was carried out to provide an electrolyte membrane/electrode assembly 9 similar to that described above. This electrolyte membrane/electrode assembly 9 is hereinafter referred to as comparative example (2).

### EXAMPLE XIII

A sulfonated PEEK having an ion-exchange capacity Ic equal to 2.4 meq/g as in EXAMPLE I was prepared as a polymer ion-exchange component. A membrane having a thickness of about 80 μm (formed using a sulfonated PEEK-PEI produced by placing a mixture of PEEK (made under a trade name of ALDRICH) and PEI (made under a trade name of ALDRICH) into fuming sulfuric acid and subjecting it to a sulfonating treatment, until an ion-exchange capacity Ic nearly equal to 0.90 meq/g was obtained) was prepared as an electrolyte membrane 2.

Thereafter, a procedure similar to that in EXAMPLE I was carried out to produce an electrolyte membrane/electrode assembly 9 similar to that described above. This electrolyte membrane/electrode assembly 9 is hereinafter referred to as comparative example (3).

### EXAMPLE XIV

A sulfonated PEEK having an ion-exchange capacity Ic equal to 2.4 meq/g as in EXAMPLE I was prepared as a polymer ion-exchange component. A membrane having a thickness of about 80 μm (formed using a sulfonated PEEK-PEI produced by placing a mixture of PEEK (made under a trade name of ALDRICH) and PEI (made under a trade name of ALDRICH) into fuming sulfuric acid and subjecting it to a sulfonating treatment, until an ion-exchange capacity Ic nearly equal to 5.5 meq/g was obtained) was prepared as an electrolyte membrane 2.

Thereafter, a procedure similar to that in EXAMPLE I was carried out to produce an electrolyte membrane/electrode assembly 9 similar to that described above. This electrolyte membrane/electrode assembly 9 is hereinafter referred to as comparative example (4).

II. Measurement of Ion-exchange Capacity Ic, Dynamic Viscoelastic Modulus Dv, Cell Potential at a Current Density of 1 A/cm² and Decrement in Thickness for Electrolytic Membrane/Electrode Assembly

As for examples (1) to (10) and comparative examples (1) to (4), ion-exchange capacity Ic was measured by utilizing titration process, and dynamic viscoelastic modulus Dv in a tensioned mode with a frequency set at 10 Hz was measured at 85° C.

A cell stack was assembled using example (1). Generation of power was carried out using the cell stack under conditions of a temperature of example (1) of 85° C.; air used as a gas, a pressure of 100 kPa and a utilization of 50% for the air pole 3; pure hydrogen used as a gas, a pressure of 100 kPa and a utilization of 50% for the fuel pole 4; and a dew point of 80° C. of each of the gases, and cell potential at a current density of 1 A/cm² was measured. The similar measurement was carried out for cell stacks made using examples (2) to (10) and comparative examples (1) to (4).

In the cell stack made using example (1), generation of power was carried out under conditions of a cell clamp pressure of 0.5 MPa, a temperature of example (1) of 90° C. and an operating time of 200 hours, and a decrement in thickness of example (1) was measured. The similar measurement was carried out for the cell stacks made using examples (2) to (10) and comparative examples (1) to (4).

Table 1 shows measurement results. In Table 1, each of the cell potentials is a value for each of the cell stacks made using example (1) and the others. For convenience, the ratio X/W of the weight X of the polymer ion-exchange component and the weight W of the catalyst particles is also given in Table 1.

TABLE 1

| | Example | | | | | | | | | | Comparative Example | | | |
|---|---|---|---|---|---|---|---|---|---|---|---|---|---|---|
| | (1) | (2) | (3) | (4) | (5) | (6) | (7) | (8) | (9) | (10) | (1) | (2) | (3) | (4) |
| Ratio X/W of | 0.63 | 0.63 | 0.63 | 0.63 | 0.05 | 0.80 | 0.63 | 0.63 | 0.02 | 1.0 | 0.63 | 0.40 | 0.63 | 0.63 |
| weights X and | | | | | | | | | | | | | | |
| W | | | | | | | | | | | | | | |
| Ion-exchange | 2.1 | 0.9 | 2.0 | 2.1 | 1.9 | 2.1 | 0.9 | 4.8 | 0.9 | 0.95 | 1.0 | 0.86 | 0.8 | 5.1 |
| capacity Ic | | | | | | | | | | | | | | |
| (meq/g) | | | | | | | | | | | | | | |
| Dynamic | 8 | 8 | 7 | 10 | 8 | 9 | 100 | 5 | 7 | 9 | 4 | 7 | 150 | 4 |
| viscoelastic | | | | | | | | | | | | | | |
| modulus Dv | | | | | | | | | | | | | | |
| (x10⁸ Pa) | | | | | | | | | | | | | | |
| Cell | 0.48 | 0.52 | 0.50 | 0.51 | 0.54 | 0.48 | 0.47 | 0.48 | 0.40 | 0.40 | 0.51 | 0.37 | 0.38 | 0.21 |
| potential | | | | | | | | | | | | | | |
| (V) | | | | | | | | | | | | | | |
| at current | | | | | | | | | | | | | | |
| density of 1 | | | | | | | | | | | | | | |
| A/cm² | | | | | | | | | | | | | | |
| Decrement in | 8 | 8 | 9 | 7 | 8 | 7 | 5 | 10 | 8 | 7 | 15 | 9 | 5 | 20 |
| thickness | | | | | | | | | | | | | | |
| (μm) | | | | | | | | | | | | | | |

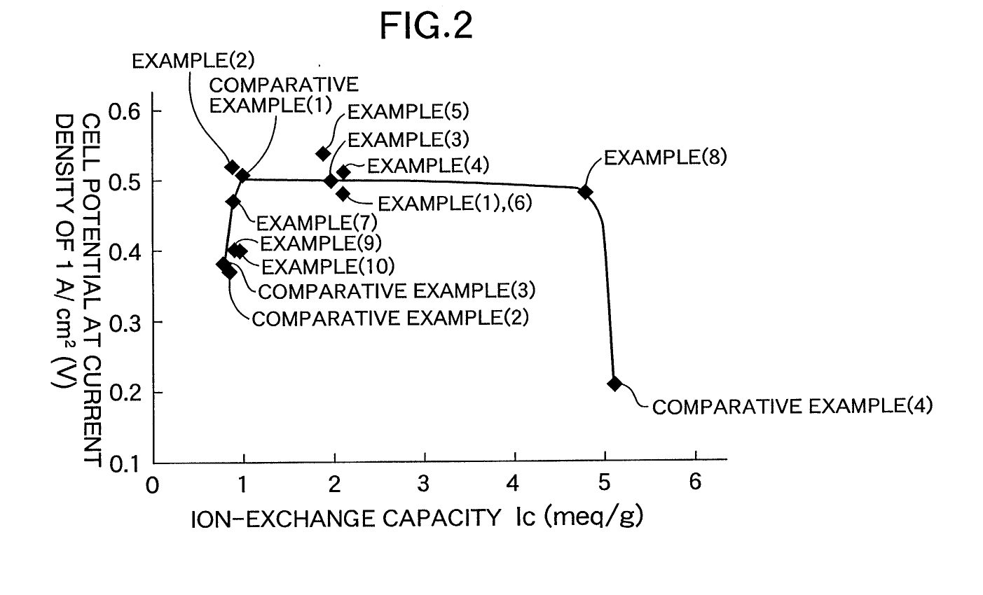

FIG. 2 is a graph made based on Table 1 and showing the relationship between the ion-exchange capacity Ic and the cell potential at the current density of 1 A/cm² for examples (1) to (10) and comparative examples (1) to (4). As apparent from FIG. 2, if the ion-exchange capacity Ic is set in a range of 0.9 meq/g≦Ic≦5 meq/gas in examples (1) to (10), the cell potential at the current density of 1 A/cm² can be maintained at a high level equal to or higher than 0.4 V which is a practical level. In this case, comparative example (1) also has a high cell potential.

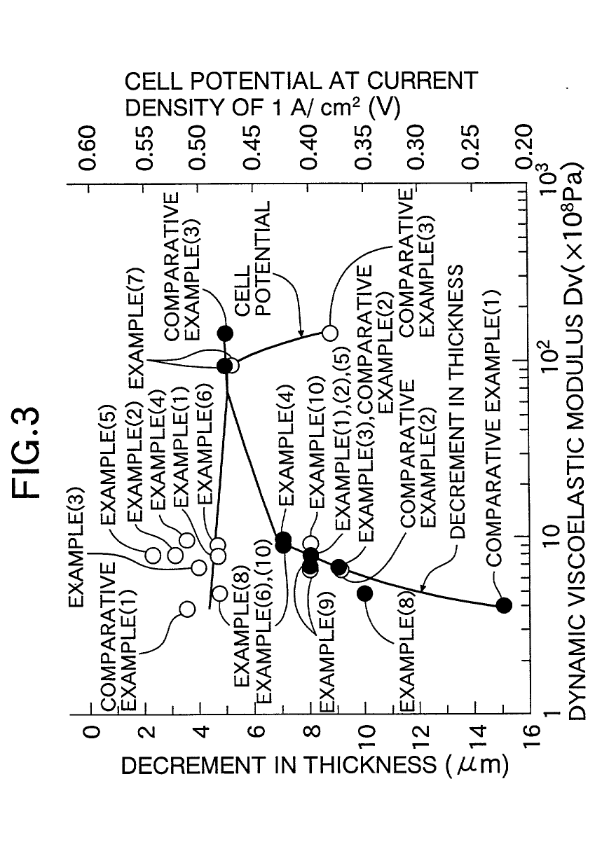

FIG. 3 is a graph made based on Table 1 and showing the relationship between the dynamic viscoelastic modulus Dv and the decrement in thickness as well as the cell potential at the current density of 1 A/cm² for examples (1) to (10) and comparative examples (1) to (4). As apparent from FIG. 3, if the dynamic viscoelastic modulus Dv is set in a range of 5×10⁸ Pa≦Dv≦1×10¹⁰ Pa as in examples (1) to (10), the decrement in thickness can be reduced to 10 μm or less, and the cell potential at the current density of 1 A/cm² can be maintained at a high level equal to or higher than 0.40 V. In this case, comparative example (1) has a dynamic viscoelastic modulus Dv of 4×10⁸ Pa, and the decrement in thickness is large because of Dv<5×10⁸ Pa. This is also applicable to the case of comparative example (4).

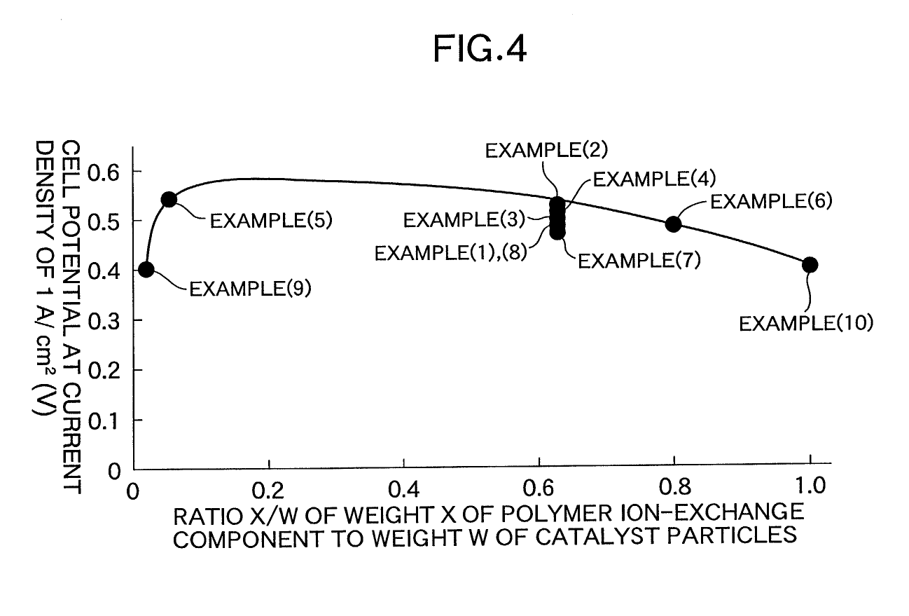

FIG. 4 is a graph made based on Table 1 and showing the relationship between the ratio X/W of the weight X of the polymer ion-exchange component to the weight W of the catalyst particles and the cell potential at the current density of 1 A/cm² for examples (1) to (10). As apparent from FIG. 4, if the ratio X/W is set in a range of 0.05≦X/W≦0.80 V on the premise that the ion-exchange capacity Ic is in the range of 0.9 meq/g≦Ic≦5 meq/g and the dynamic viscoelastic modulus Dv is in the range of 5×10⁸ Pa≦Dv≦1×10¹⁰ Pa, as in examples (1) to (8), the cell potential at the current density of 1 A/cm² can be maintained at a high level equal to or higher than 0.47.

### EXAMPLE II

In the solid polymer electrolyte fuel cell 1 shown in FIG. 1, each of the polymer ion-exchange component forming the electrolyte membrane 2 and the polymer ion-exchange component included in each of the air pole 3 and the fuel pole 4 is an aromatic hydrocarbon polymer ion-exchange component. Such polymer ion-exchange component has a characteristic that it is free of a fluorine and soluble in a solvent. Examples of such polymer ion-exchange components which may be used are sulfonated substances of polyether-ether ketone (PEEK), polyether sulfone (PES), polysulfone (PSF), polyetherimide (PEI), polyphenylene sulfide (PPS), polyphenylene oxide (PPO). These substances have been described in EXAMPLE I. Examples of the solvents which may be used are various polar solvents such as dimethylacetoamide (DMAc having a boiling point of 165.5° C.), dimethylformamide (DMF having a boiling point of 153° C.), dimethylsulfoxide (DMSO having a boiling point of 189° C.), triethylphosphate (TEP having a boiling point of 115° C.), N-methylpyrrolidone (NMP having a boiling point of 202° C.).

It is preferable that the solubility of the first aromatic hydrocarbon polymer ion-exchange component forming the electrolyte membrane 2, namely, the first polymer ion-exchange component in the solvent and the solubility of the second aromatic hydrocarbon polymer ion-exchange component in each of the air pole 3 and the fuel pole 4, namely, the second polymer ion-exchange component in the solvent are such that the latter is larger than the former. This is because the second polymer ion-exchange component in each of the air pole 3 and the fuel pole 4 is thermally deteriorated greatly being extremely close to a site where a catalytic reaction occurs, and for this reason, the air pole 3 and the fuel pole 4 are recovered and discarded earlier than the electrolyte membrane 2. Thus, it is possible to increase the purity of the first polymer ion-exchange component in the electrolyte membrane 2.

If the first and second polymer ion-exchange components are the same substance or of the same type, a difference in solubility between the first and second components is achieved by providing a difference between average molecular weights of the polymer ion-exchange components. Namely the substance having a lower average molecular weight is dissolved more easily than the substance having a higher average molecular weight. For example, if the average molecular weight of the first polymer ion-exchange component is represented by A, and the average molecular weight of the second polymer ion-exchange component is represented by B, it is preferable that the ratio B/A of the average molecular weights is in a range of 0.1≦B/A≦1.0, on the premise that each of the first and second polymer ion-exchange components has an average molecular weight equal to or larger than 5,000 in consideration of the durability. However, if the ratio B/A is smaller than 0.1, the durability of the air pole 3 and the fuel pole 4 is reduced, resulting in a largely declined thickness-retaining ability and for this reason, the power-generating ability or the like is significantly changed with the passage of time. On the other hand, if B/A≦1.0, the rate of recovery of the first polymer ion-exchange component forming the electrolyte membrane 2 is decreased.

Two types of first and second polymer ion-exchange components having different solubilities in a solvent and different chemical compositions may be used.

Particular examples will be described below.

I. Production of Electrolyte Membrane/Electrode Assembly

Platinum (pt) particles having an average particle size of 3 nm were carried on carbon black particles (under a trade name of Ketjen Black EC) to prepare catalyst particles including the Pt particles in a content of 50% by weight.

### EXAMPLE I

A first polymer ion-exchange component which was sulfonated PEEK and had an average molecular weight A of 50,000 and a second polymer ion-exchange component which was sulfonated PEEK and had an average molecular weight B of 45,000 were prepared as aromatic hydrocarbon polymer ion-exchange components (a ratio B/A was equal to 0.9).

An electrolyte membrane 2 having a thickness of 50 μm was formed using the first polymer ion-exchange component. The second polymer ion-exchange component was dissolved in NMP under reflux to prepare a solution of the second polymer ion-exchange component included in a content of 6% by weight in the NMP.

Catalyst particles were mixed into the solution including the second polymer ion-exchange component, so that the ratio of the second polymer ion-exchange component to the catalyst particles was equal to 3:5 by weight. Then, the catalyst particles were dispersed using a ball mill to provide a slurry for each of an air pole 3 and a fuel pole 4. This slurry was applied onto opposite sides of the electrolyte membrane 2, so that a Pt content of 0.5 mg/cm² was achieved. After drying the slurry, a porous carbon plate as each of diffusion layers 5 and 6 which had been subjected to a water-repellency providing treatment was put on each of the coating layers and subjected to hot-pressing under conditions of 140° C., 1.5 MPa and 1 minute, to provide an electrolyte membrane/electrode assembly 9 having a pair of diffusion layers 5 and 6. This electrolyte membrane/electrode assembly 9 is hereinafter referred to as example (11).

### EXAMPLE II

A first polymer ion-exchange component which was sulfonated PEEK and had an average molecular weight A of 50,000 and a second polymer ion-exchange component which was sulfonated PEEK and had an average molecular weight B of 45,000 were prepared as aromatic hydrocarbon polymer ion-exchange components (a ratio B/A was equal to 0.9) as in EXAMPLE I.

Thereafter, a procedure similar to that in EXAMPLE I, except that the temperature in the hot-pressing was set at 200° C., was carried out to provide an electrolyte membrane/electrode assembly 9. This electrolyte membrane/electrode assembly 9 is hereinafter referred to as example (12).

### EXAMPLE III

A first polymer ion-exchange component which was sulfonated PES and had an average molecular weight A of 50,000 and a second polymer ion-exchange component which was sulfonated PES and had an average molecular weight B of 45,000 were prepared as aromatic hydrocarbon polymer ion-exchange components (a ratio B/A was equal to 0.9).

Thereafter, a procedure similar to that in EXAMPLE I, except that the temperature in the hot-pressing was set at 190° C., was carried out to provide an electrolyte membrane/electrode assembly 9. This electrolyte membrane/electrode assembly 9 is hereinafter referred to as example (13).

### EXAMPLE IV

A first polymer ion-exchange component which was sulfonated PSF and had an average molecular weight A of 50,000 and a second polymer ion-exchange component which was sulfonated PSF and had an average molecular weight B of 25,000 were prepared as aromatic hydrocarbon polymer ion-exchange components (a ratio B/A was equal to 0.5).

Thereafter, a procedure similar to that in EXAMPLE I, except that the temperature in the hot-pressing was set at 170° C., was carried out to provide an electrolyte membrane/electrode assembly 9. This electrolyte membrane/electrode assembly 9 is hereinafter referred to as example (14).

### EXAMPLE V

A first polymer ion-exchange component which was sulfonated PSF as in EXAMPLE I and had an average molecular weight A of 50,000 and a second polymer ion-exchange component which was sulfonated PSF and had an average molecular weight B of 12,500 were prepared as aromatic hydrocarbon polymer ion-exchange components (a ratio B/A was equal to 0.25).

Thereafter, a procedure similar to that in EXAMPLE I, except that the temperature in the hot-pressing was set at 170° C. as in EXAMPLE IV, was carried out to provide an electrolyte membrane/electrode assembly 9. This electrolyte membrane/electrode assembly 9 is hereinafter referred to as example (15).

### EXAMPLE VI

A first polymer ion-exchange component which was sulfonated PEEK as in EXAMPLE I and had an average molecular weight A of 50,000 and a second polymer ion-exchange component which was sulfonated PEEK as in EXAMPLE I and had an average molecular weight B of 50,000 were prepared as aromatic hydrocarbon polymer ion-exchange components (a ratio B/A was equal to 0.1).

Thereafter, a procedure similar to that in EXAMPLE I, except that the temperature in the hot-pressing was set at 170° C. as in EXAMPLE IV, was carried out to provide an electrolyte membrane/electrode assembly 9. This electrolyte membrane/electrode assembly 9 is hereinafter referred to as example (16).

### EXAMPLE VII

A first polymer ion-exchange component which was sulfonated PEEK as in EXAMPLE I and had an average molecular weight A of 50,000 and a second polymer ion-exchange component which was sulfonated PEEK as in EXAMPLE I and had an average molecular weight B of 2,500 were prepared as aromatic hydrocarbon polymer ion-exchange components (a ratio B/A was equal to 0.05).

Thereafter, a procedure similar to that in EXAMPLE I, except that the temperature in the hot-pressing was set at 170° C. as in EXAMPLE IV, was carried out to provide an electrolyte membrane/electrode assembly 9. This electrolyte membrane/electrode assembly 9 is hereinafter referred to as comparative example (5).

### EXAMPLE VIII

A first polymer ion-exchange component which was sulfonated PEEK as in EXAMPLE I and had an average molecular weight A of 50,000 and a second polymer ion-exchange component which was sulfonated PEEK as in EXAMPLE I and had an average molecular weight B of 75,000 were prepared as aromatic hydrocarbon polymer ion-exchange components (a ratio B/A was equal to 1.5).

Thereafter, a procedure similar to that in EXAMPLE I, except that the temperature in the hot-pressing was set at 170° C. as in EXAMPLE IV, was carried out to provide an electrolyte membrane/electrode assembly 9. This electrolyte membrane/electrode assembly 9 is hereinafter referred to as comparative example (6).

II. Recovery of First Polymer Ion-exchange Component Forming Electrolyte Membrane

Example (11) was immersed into DMAc (having a boiling point of 165.5° C.) and then, the DMAc was heated to 165° C., thereby dissolving the second polymer ion-exchange component for forming each of the air pole 3 and the fuel pole 4. The electrolyte membrane 2 and the diffusion layers 5 and 6 were removed out of the DMAc, and the DMAc was subjected to a filtration under pressure, whereby the mixture of the catalyst particles and the second polymer ion-exchange component was separated from the DMAc. The mixture was burned to recover the catalyst particles.

On the other hand, the electrolyte membrane 2 was dissolved into a new solvent comprising DMAc and then, the DMAc was heated to 165° C., thereby completely dissolving the electrolyte membrane 2, i.e., the second polymer ion-exchange component. The resulting solution was maintained at a heated state and thus concentrated, until the remainder was 50% by volume or less. Acetone was added to the resulting concentrated solution, whereby the first polymer ion-exchange component was precipitated and then recovered by filtration.

An operation similar to that described above was carried out for examples (12) to (16) and comparative examples (5) and (6) to recover the catalyst particles and the first polymer ion-exchange component.

Then, a recovery rate F was calculated according to an equation, F=(E/D)×100 (%) wherein D represents the weight of the first polymer ion-exchange component at the beginning, and E represents the weight of the first polymer ion-exchange component recovered.

Examples (12) to (16) and comparative examples (5) and (6) were subjected to a compression durability test under conditions of 150° C., a humidity of 80%, a surface pressure of 0.8 MPa and 200 hours, whereby the thickness-retaining rate H of the electrolyte membrane 2 and the thickness-retaining rate J of the air pole (or the fuel pole 4) were determined, and then, the ratio percent K of the thickness-retaining rates H and J was calculated according to an equation, K=(J/H)×100 (%).

Table 2 shows the ratio B/A of the average molecular weights A and B of the first and second polymer ion-exchange components, the recovery rate F of the first polymer ion-exchange component and the ratio percent K of the thickness-retaining rates H and J for examples (11) to (16) and comparative examples (5) and (6).

TABLE 2

| | | Recovery rate F | Ratio percent |
|---|---|---|---|
| | Ratio B/A | (%) of first | K (%) of the |
| Electrolyte | of average | polymer ion- | thickness |
| membrane/electrode | molecular | exchange | retaining |
| assembly | weights | component | rates |
| Example (11) | 0.9 | 90 | 98 |
| Example (12) | 0.9 | 90 | 98 |
| Example (13) | 0.9 | 90 | 98 |
| Example (14) | 0.5 | 92 | 94 |
| Example (15) | 0.25 | 92 | 92 |
| Example (16) | 0.1 | 92 | 88 |
| Comparative | 0.05 | 91 | 64 |
| Example (5) | | | |
| Comparative | 1.5 | 52 | 100 |
| Example (6) | | | |

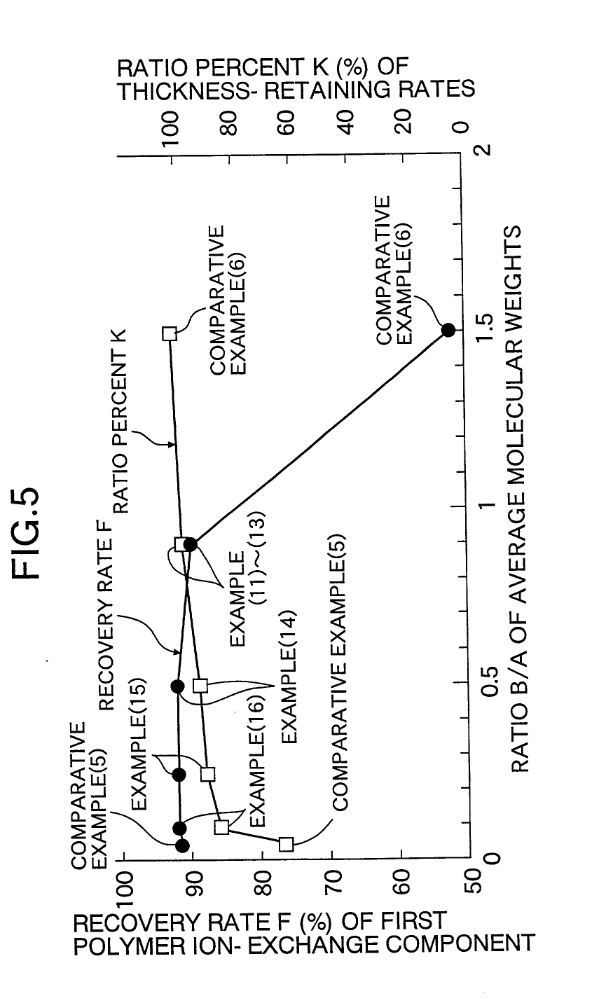

FIG. 5 is a graph made based on Table 1 and showing the relationship between the ratio B/A of the average molecular weights and the recovery rate F of the first ion-exchange component as well as the ratio percent K of the thickness-retaining rates.

As apparent from Table 2 and FIG. 5, the recovery rate F of the first polymer ion-exchange component and the ratio percent K of the thickness-retaining rates are higher in examples (11) to (16). This is attributable to that the average molecular weights A and B are equal to or higher than 5,000, and the ratio B/A is in the range of 0.1≦B/A≦1.0.

In comparative example (5), the recovery rate F of the first polymer ion-exchange component is higher, because the average molecular weight B of the second polymer ion-exchange component is equal to or higher than 5,000, but the compression durability of the air pole 3 is lower and hence, the ratio percent K is decreased. On the other hand, in comparative example (6), the recovery rate F of the first polymer ion-exchange component is remarkably decreased, because the first polymer ion-exchange component is dissolved more easily than the second polymer ion-exchange component with the rate B/A being 1.0 or higher.

III. Correlation Between Presence or Absence of Water-repellency and Power-generating Performance

(1) Production of Example (17)

Platinum (Pt) particles having an average particle size of 3 nm were carried on first carbon black particles (under a trade name of Ketjen Black EC) to prepare catalyst particles for a fuel pole 4 including the Pt particles in a content of 50% by weight.

In addition, Platinum (Pt) particles having an average particle size of 3 nm were carried on second carbon black particles (under a trade name of Vulcan XC-72) to prepare catalyst particles for an air pole 3 including the Pt particles in a content of 50% by weight.

A first polymer ion-exchange component which was sulfonated PEEK as in EXAMPLE I and had an average molecular weight A of 50,000 and a second polymer ion-exchange component which was sulfonated PEEK as in EXAMPLE I and had an average molecular weight B of 45,000 were prepared as aromatic hydrocarbon polymer ion-exchange components (a ratio B/A was equal to 0.9).

An electrolyte membrane 2 having a thickness of 50 μm was formed using the first polymer ion-exchange component. The second polymer ion-exchange component was dissolved into NMP under reflux to prepare a solution of the second polymer ion-exchange component included in a content of 6% by weight.

Catalyst particles were mixed into the solution including the second polymer ion-exchange component, so that the ratio of the second polymer ion-exchange component to the catalyst particles for a fuel pole equal to 3:5 by weight was obtained. Then, the catalyst particles were dispersed using a ball mill, thereby preparing a slurry for the fuel pole 4.

In addition, catalyst particles were mixed into the solution including the second polymer ion-exchange component, so that the ratio of the second polymer ion-exchange component to the catalyst particles for an air pole 3 equal to 3:5 by weight was obtained. Then, the catalyst particles were dispersed using a ball mill, thereby preparing a slurry for the air pole 3.

The slurries were applied onto opposite sides of the electrolyte membrane 2, respectively, so that the Pt content was 0.5mg/cm². After drying, carbon papers as diffusion layers 5 and 6 were put on the coating layers and subjected to hot-pressing under conditions of 140° C., 1.5 MPa and 1 minute to provide an electrolyte membrane/electrode assembly 9 having a pair of diffusion layers 5 and 6. This electrolyte membrane/electrode assembly 9 is hereinafter referred to as example (17).

(2) Production of Comparative Example (7)

Polytetrafluoroethylene (PTFE) was added as a water-repellent to a slurry for an air pole 3 as described in the production of example (17), to prepare a new slurry for the air pole 3. In this case, the amount L of PTFE added was set at 10% by weight of a sum M of the weights of the second polymer ion-exchange component and the catalyst particles for the air pole 3, namely, L=0.1 M.

A procedure similar to that described in the case of example (17), except that the above-described slurry for the air pole 3 including PTFE was used, was carried out to provide an electrolyte membrane/electrode assembly 9. This electrolyte membrane/electrode assembly 9 is hereinafter referred to as comparative example (7).

(3) A solid polymer electrolyte fuel cell was assembled using example (17) and operated to generate a power, and the relationship between the current density and the terminal voltage was measured. A similar operation was carried out for comparative example (7).

Table 3 shows measurement results. In Table 3, the indication “cell [Ex.(17)]” means a cell made using example (17), and the indication “cell [Com.(7)]” means a cell made using comparative example (7). This is also applicable to the descriptions made hereinafter. The amount of water absorbed at 60° C. was 370 cc/g in the Ketjen Black EC and 72 cc/g in the Vulcan XC-72.

TABLE 3

| | |
|---|---|
| Current density | Terminal voltage (V) |

| (A/cm²) | Cell [Ex. (17)] | Cell [Com. (7)] |
|---|---|---|
| 0.0 | 0.95 | 0.96 |
| 0.1 | 0.82 | 0.83 |
| 0.2 | 0.77 | 0.78 |
| 0.3 | 0.72 | 0.72 |
| 0.4 | 0.7 | 0.7 |
| 0.5 | 0.67 | 0.68 |
| 0.6 | 0.65 | 0.66 |
| 0.7 | 0.62 | 0.64 |
| 0.8 | 0.58 | 0.59 |
| 0.9 | 0.54 | 0.55 |
| 1.0 | 0.5 | 0.51 |
| 1.1 | 0.46 | 0.48 |
| 1.2 | 0.42 | 0.43 |
| 1.3 | 0.38 | 0.38 |
| 1.4 | 0.33 | 0.33 |
| 1.5 | 0.24 | 0.24 |

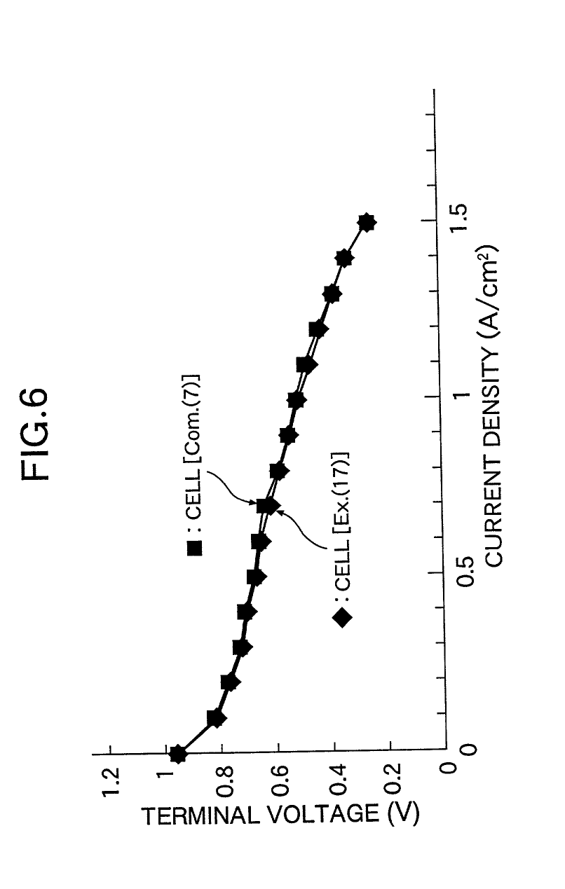

FIG. 6 is a graph made based on Table 3 and showing the relationship between the current density and the terminal potential. As apparent from Table 3 and FIG. 6, the cell [Com.(7)] made using PTFE as the water-repellant is slightly excellent in power-generating performance, as compared with the cell [Ex.(17)] having no PTFE, but a difference between the power-generating performances is as very small as a difference of 10 mV between terminal potentials at a current density of 1.0 A/cm².

In example (17) and comparative example (7), the electrolyte membrane 2, namely, the first polymer ion-exchange component exhibited the same recovery rate, but the recovery of the catalyst particles from the air pole 3 is very difficult in the case of comparative example (7), because the latter includes PTFE.

Although the embodiments of the present invention have been described in detail, it will be understood that the present invention is not limited to the above-described embodiments, and various modifications in design may be made without departing from the spirit and scope of the invention defined in claims.

What is claimed is:

1. An electrolyte membrane/electrode assembly of a solid polymer electrolyte fuel cell, comprising an electrolyte membrane, and an air pole and a fuel pole provided to sandwich said electrolyte membrane therebetween, each of said electrolyte membrane, said air pole and said fuel pole including a polymer ion-exchange component, wherein said electrolyte membrane/electrode assembly has an ion-exchange capacity Ic in a range of 0.9 meq/g≦Ic≦5 meq/g, and a dynamic viscoelastic modulus at 85° C. in a range of 5×10⁸ Pa≦Dv≦1×10¹⁰ Pa.

2. An electrolyte membrane/electrode assembly of a solid polymer electrolyte fuel cell according to claim 1, wherein if the weight of said catalyst particles included in each of said air pole and said fuel pole is represented by W, and the weight of said polymer ion-exchange component included in each of said air pole and said fuel pole is represented by X, the ratio X/W of the weights W and X is in a range of 0.05≦X/W≦0.80.

3. An electrolyte membrane/electrode assembly of a solid polymer electrolyte fuel cell according to claim 1 or 2, wherein said polymer ion-exchange component is an aromatic hydrocarbon polymer ion-exchange component free of fluorine and soluble in a solvent.

4. An electrolyte membrane/electrode assembly of a solid polymer electrolyte fuel cell according to claim 3, wherein said electrolyte membrane includes a first aromatic hydrocarbon ion-exchange component, and each of said air pole and said fuel pole includes a second aromatic hydrocarbon ion-exchange component, the solubilities of said first and second aromatic hydrocarbon ion-exchange components in a solvent being such that the solubility of said second aromatic hydrocarbon ion-exchange component is larger than that of said first aromatic hydrocarbon ion-exchange component.
